(19) United States
(12) Patent Application Publication
(10) Pub. No.: US 2011/0074979 A1
(43) Pub. Date: Mar. 31, 2011

(54) IMAGE CAPTURE DEVICE

(75) Inventors: WEI HUANG, Foshan (CN); XUE-LAN ZHOU, Foshan (CN); QI-DA GUAN, Foshan (CN)

(73) Assignees: PREMIER IMAGE TECHNOLOGY(CHINA) LTD., Foshan City (CN); HON HAI PRECISION INDUSTRY CO., LTD., Tu-Cheng (TW)

(21) Appl. No.: 12/764,239

(22) Filed: Apr. 21, 2010

(30) Foreign Application Priority Data
Sep. 30, 2009 (CN) 200910308005.X

(51) Int. Cl. H04N 5/262

(52) U.S. Cl. 348/240.99; 348/E05.055

(57) ABSTRACT

An image capture device includes a face recognition module, a determination module, and an image edition module. The face recognition module recognizes a facial portion of a portrait photo. The determination module zooms the portrait photo until the facial portion satisfies first predetermined sizes, calculates the center of the facial portion, and determines a boundary of a photo identification to be created in the zoomed portrait photo according to second predetermined sizes, which interprets the center of the facial portion as the center thereof. The image edition module cuts the zoomed portrait photo along the boundary to create the photo identification.

### BACKGROUND

1. Technical Field

The present disclosure relates to image capture devices, and particularly, to an image capture device for creating photo identifications (IDs).

2. Description of Related Art

The process of capturing an image by an image capture device, transmitting, and then editing it, typically on a computer, to meet specific size requirements, is a resolvable inconvenience.

Therefore, it is desirable to provide an image captured device, which can overcome the above-mentioned limitations.

### BRIEF DESCRIPTION OF THE DRAWINGS

FIG. 1 is a functional diagram of an image capture device, according to one embodiment.

FIG. 2 is a schematic view showing how a portrait photo is converted into a corresponding photo ID by the image capture device of FIG. 1.

FIG. 3 is a rear planar view of the image capture device of FIG. 1.

FIG. 4 is a rear planar view of the image capture device, according to another embodiment.

### DETAILED DESCRIPTION

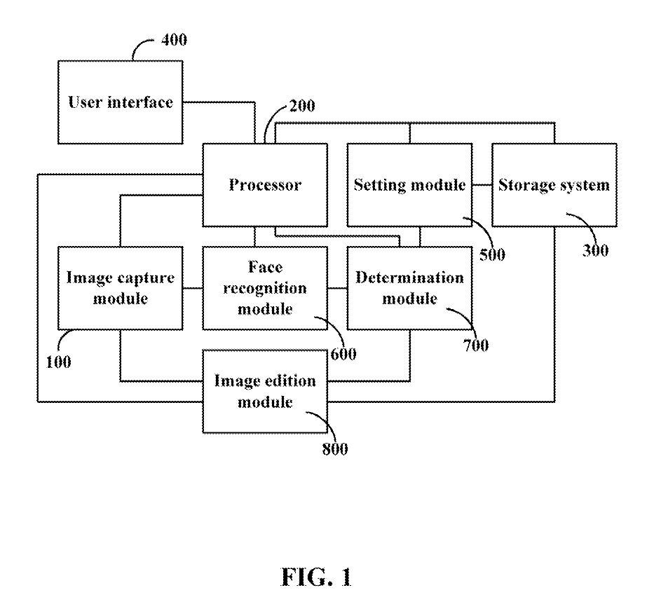

Referring to FIG. 1, an image capture device 10, according to one embodiment, is a digital still camera. However, the image capture device 10 is not limited to this embodiment but can be any image capture-ready device, such as a web-cam or cell phone.

The image capture device 10 includes an image capture module 100, a processor 200, a storage system 300, a user interface 400, a setting module 500, a face recognition module 600, a determination module 700, and an image edition module 800.

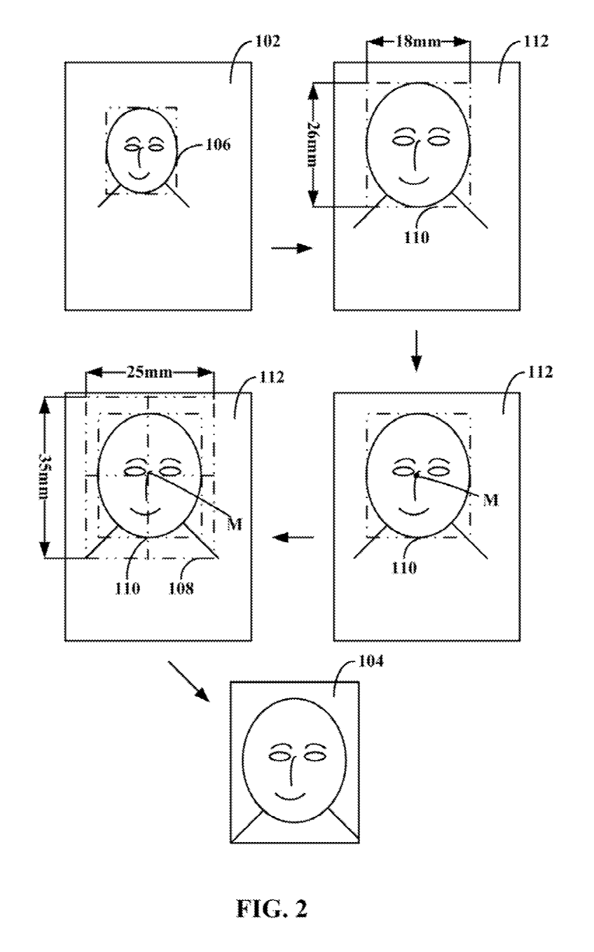

Also referring to FIG. 2, the image capture module 100 such as a camera module is configured to capture a portrait photo 102.

The setting module 500, the face recognition module 600, the determination module 700, and the image edition module 800, may be embodied in, and fully automated via software code modules executed by one or more general purpose computers or processors, for example, the processor 200. The software code modules may be stored in any type of computer-readable medium or other storage device, for example, the storage system 300. Alternatively, some or all of the modules may be embodied in specialized computer hardware or communication apparatus.

The storage system 300 stores a number of different size settings of photo IDs. Commonly, driver license and other ID cards of different countries, have different photo ID size requirements. For example, Chinese ID cards require a 1-inch photo (25 mm×35 mm) of which a facial portion is about 18 mm×26 mm.

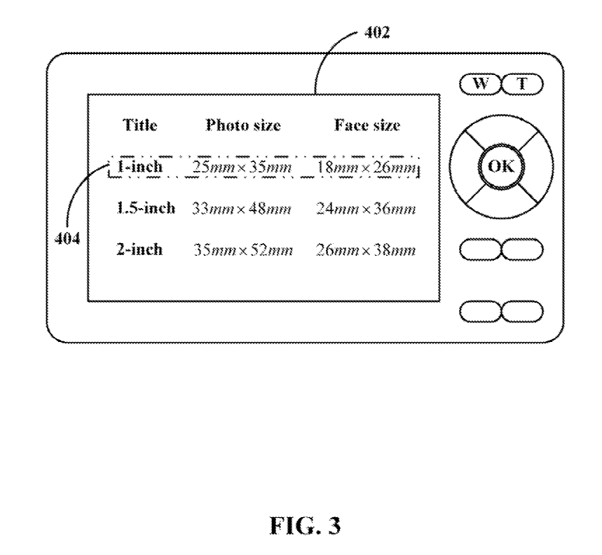

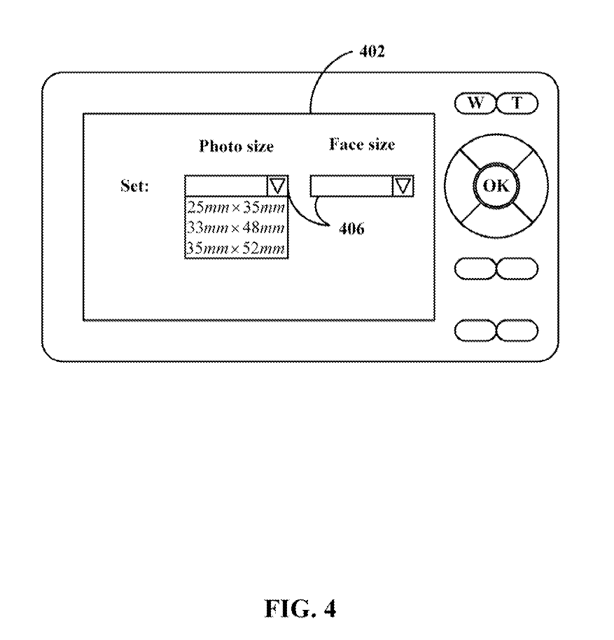

The user interface 400 is configured for user interaction with the image capture device 10. For example, the user interface 400 can display information such as a preview of portrait photo to the user and/or receive user inputs by the user. Referring to FIGS. 3-4, the user interface 400 can include a touch panel 402.

The setting module 500 is configured to set sizes of photo IDs to be created by the image capture device 10, responding to user inputs through the user interface 400. For example, the setting module 500 can display the size settings as options 404 on the touch panel 402 (see FIG. 3). The setting module 500 then sets sizes of the photo IDs to be created in response to contacts with the touch panel 402 (i.e., a user input). As shown in FIG. 3, the setting module 500 drives the touch panel 402 to show the following options 404: “1-inch,” “1.5-inch,” and “2-inch,” and sets the size of a photo ID to be created as: 25 mm×35 mm (photo size) and 18 mm×26 mm (facial portion size) by touching the corresponding option 404. Alternatively, as shown in FIG. 4, the setting module 500 can also drive the touch panel 402 to display editable dialog windows 406, whereby the setting module 500 can determine the sizes of the photo IDs to be created in response to user edits of the windows 406.

In FIGS. 1-2, the face recognition module 600 is configured to recognize a facial portion 106 of the portrait photo 102. Many algorithms including nerve network, nerve network plus fast Fourier transform, fuzzy plus nerve network, RGB normalized color, fuzzy color, principle component analysis, and algorithm template, are usable by the face recognition module 600.

The determination module 700 determines a boundary 108 of a photo ID 104 to be converted from the portrait photo 102 based upon the set sizes and the recognized facial portion 106. In particular, the determination module 700 is configured to zoom in or out the portrait photo 102 until the zoomed facial portion 110 meets preset size requirements, for example, a width of 18 mm and a height of 26 mm, and to calculate coordinates of the center M and to determine the boundary 108 of the photo ID 104 which interprets the center M of the zoomed facial portion 110 as the center thereof.

The image edition module 800 is configured to cut the zoomed portrait photo 112 along the boundary 108 to create the photo ID 104.

While various embodiments have been described, it is to be understood that the disclosure is not limited thereto. To the contrary, various modifications and similar arrangements (as would be apparent to those skilled in the art), are also intended to be covered. Therefore, the scope of the appended claims should be accorded the broadest interpretation so as to encompass all such modifications and similar arrangements.

What is claimed is:

1. An image capture device comprising:
a face recognition module configured to recognize a facial portion of a portrait photo;
a determination module configured to zoom the portrait photo until the facial portion satisfies first predetermined sizes, calculate the center of the facial portion, and determine a boundary of a photo identification to be created in the zoomed portrait photo according to second predetermined sizes, the second predetermined sizes taking the center of the facial portion as the center thereof; and
an image edition module configured to cut the zoomed portrait photo along the boundary to create the photo identification.

2. The image capture device of claim 1, further comprising an image capture module configured to capture the portrait.

3. The image capture device of claim 1, further comprising a storage system configured to store a number of size settings of a plurality of types of photo identification, the first and second predetermined sizes being defined in one of the photo identifications.

4. The image capture device of claim 1, further comprising a user interface configured for user interaction with the image capture device.

5. The image capture device of claim 1, wherein the user interface comprises a touch panel.

6. The image capture device of claim 1, further comprising a setting module configured to set the first and second predetermined sizes.
